(19) United States
(12) Patent Application Publication
(10) Pub. No.: US 2023/0263111 A1
(43) Pub. Date: Aug. 24, 2023

(54) METHOD FOR CULTIVATING COTTON AND PLANT ACTIVATOR FOR CULTIVATING COTTON

(71) Applicant: SHOWA DENKO K.K., Tokyo (JP)

(72) Inventors: Makoto SAITO, Tokyo (JP); Hiroshi UCHIDA, Tokyo (JP); Ichiro FUJITA, Tokyo (JP)

(73) Assignee: SHOWA DENKO K.K., Tokyo (JP)

(21) Appl. No.: 18/006,998

(22) PCT Filed: Jul. 19, 2021
(86) PCT No.: PCT/JP2021/027029

§ 371 Date: Jan. 26, 2023

(30) Foreign Application Priority Data
Jul. 28, 2020 (JP) 2020-127285

(51) Int. Cl. A01G 22/50; A01N 43/16; A01P 21/00

(52) U.S. Cl. CPC A01G 22/50; A01N 43/16; A01P 21/00

(57) ABSTRACT

Provided is a method for improving the cotton crop yield. This method for cultivating cotton comprises treating seedlings at least once with a plant activator containing an exogenous elicitor and an endogenous elicitor.

### FIELD

The present invention relates to a method for cultivating cotton using a plant-vitalizing agent comprising an exogenous elicitor and an endogenous elicitor, and to a plant-vitalizing agent for cultivating cotton.

### BACKGROUND

15 Plants suffer reduction in yields due to abiotic stress as a result of daylight exposure time, atmospheric temperature and rainfall, and biological stress such as pests. In the case of cotton, for example, a high intensity of solar radiation is desirable, with an optimum daytime temperature of 30 to 35° C. An annual mean temperature of 15° C. or higher and a frost-free period of 180 to 200 days or longer are necessary for growth, with poor growth resulting outside of these ranges. Excessive humidity conditions can also tend to cause problems such as disease. Various types of fertilizers and agricultural chemicals have been used in the prior art to increase yields, especially of agricultural crops. Fertilizers are used as the nutrients required for plant growth, but they lack functions for alleviating stress. Agricultural chemicals directly eliminate pests that parasitize plants and thus eliminate biological stress, but the safety of using agricultural chemicals has not been adequately confirmed, and concerns remain regarding the effects of their excess consumption on the human body and on the environment, while chemical agents such as agricultural chemicals produced by chemical synthesis methods are also especially concerning in terms of their dispersion and residence for long periods in soil, for which reasons other methods are desired to provide resistance against biological stress. In recent years, the use of biostimulants has become a subject of interest in light of their safety for the human body and the environment.

The term “biostimulant”, sometimes synonymous with “plant-vitalizing agent”, refers to a component that contains a substance group or microorganism and, when applied to the plant 35 body or its root system, stimulates the series of processes that take place in the plant body in its natural state, thereby improving nutrient absorption, increasing fertilization efficiency, providing stress resistance and improving quality, while also lacking any direct effect against pests so that it is not classified as an insecticide or microbicide. In other words, it is a component found in the natural world (including microorganisms), being a substance which is not a plant hormone or nutrient but which, even in small amounts, stimulates plant activity and promotes growth. Applying a biostimulant to a plant increases nutrient absorption and nutrient utilization in the plant, promoting its growth and improving the yield and quality of crops. Agricultural biostimulants include various formulations such as compounds, substances or other products that act on plants or soil to regulate and reinforce physiological processes in crops. Biostimulants act on plant physiology by a different route than that of nutrients to improve crop vitality, yield, quality and post-harvesting storage life.

Biostimulants can therefore stimulate the innate abilities of plants and promote their growth without causing problems associated with conventional agricultural chemicals or fertilizers.

Previous publications related to such biostimulants have contained descriptions of: plant-vitalizing agents that combine chitin oligosaccharides with chitosan which exhibits antimicrobial activity (PTL 1), plant-vitalizing agents combining oligosaccharides and plant extract components in vinegar (PTL 2), plant growth accelerators that include cellulose (PTL 3), plant growth regulators that include hexofuranose derivatives (PTL 4), a method of increasing plant disease resistance using low molecularized chitin or chitosan (PTL 5), and fertilizers containing chitin and/or chitosan (PTL 6).

### CITATION LIST

### Patent Literature

[PTL 1] Japanese Unexamined Patent Publication HEI No. 9-143013
[PTL 2] Japanese Unexamined Patent Publication No. 2001-64112
[PTL 3] Japanese Unexamined Patent Publication No. 2002-114610
[PTL 4] Japanese Unexamined Patent Publication No. 2013-151438
[PTL 5] Japanese Unexamined Patent Publication No. 2015-48436
[PTL 6] Japanese Unexamined Patent Publication No. 2017-95352
[PTL 7] International Patent Publication No. WO2017/104687

### SUMMARY

### Technical Problem

Despite the above, no studies have been conducted in regarding to adjusting the manner in which plant-vitalizing agents are provided for different plant varieties during cultivation of plants in order to increase their effects. In particular, no method has been known for applying plant-vitalizing agents in a manner suited for cotton.

### Solution to Problem

The present invention has been devised in light of the situation described above, on the basis of much diligent research regarding the use of plant-vitalizing agents for cultivation of cotton. As a result, it was found that harvest yields are markedly increased if a plant-vitalizing agent comprising an exogenous elicitor and an endogenous elicitor is applied to cotton seedlings, and the invention was thus completed.

Specifically, the present invention encompasses the following [1] to [22].

[1] A method for cultivating cotton, wherein the method comprises applying a plant-vitalizing agent comprising an exogenous elicitor and an endogenous elicitor at least once to a seedling of the plant.

[2] The method for cultivating cotton according to [1], wherein the method comprises applying a plant-vitalizing agent to a seedling of the plant at least once at 2 to 15 days after germination.

[3] The method for cultivating cotton according to [1] or [2], wherein the method comprises applying a plant-vitalizing agent to a plant body at least once after the seedling stage.

[4] The method for cultivating cotton according to any one of [1] to [3], wherein the exogenous elicitor is a chitin oligosaccharide, and the endogenous elicitor is at least one type of oligosaccharide selected from among cellooligosaccharides and xylooligosaccharides.

[5] The method for cultivating cotton according to any one of [1] to [4], wherein the mass ratio of the exogenous elicitor with respect to the endogenous elicitor in the plant-vitalizing agent is 0.1 to 5.

[6] The method for cultivating cotton according to any one of [1] to [5], which comprises a xylooligosaccharide as the endogenous elicitor.

[7] The method for cultivating cotton according to [6], which comprises both a cellooligosaccharide and a xylooligosaccharide as the endogenous elicitor.

[8] The method for cultivating cotton according to [7], wherein the mass ratio of the cellooligosaccharide with respect to the xylooligosaccharide in the plant-vitalizing agent is 0.2 to 5.

[9] The method for cultivating cotton according to any one of [1] to [8], which comprises applying the plant-vitalizing agent to a plant at a concentration so that the total content of the exogenous elicitor and the endogenous elicitor is 0.1 to 500 ppm by mass.

[10] The method for cultivating cotton according to any one of [1] to [9], which comprises applying the plant-vitalizing agent to a plant by foliar application.

[11] The method for cultivating cotton according to any one of [1] to [10], wherein the cotton is of the species hirsutum.

[12] A plant-vitalizing agent comprising an exogenous elicitor and an endogenous elicitor, to be used for cultivation of cotton, which is applied at least one time to a seedling of the plant.

[13] The plant-vitalizing agent according to [12], which is applied at least once to the seedling 2 to 15 days after germination.

[14] The plant-vitalizing agent according to [12] or [13], which is applied at least once to the plant body after the seedling stage.

[15] The plant-vitalizing agent according to any one of [12] to [14], wherein the exogenous elicitor is a chitin oligosaccharide, and the endogenous elicitor is at least one type of oligosaccharide selected from among cellooligosaccharides and xylooligosaccharides.

[16] The plant-vitalizing agent according to any one of [12] to [15], wherein the mass ratio of the exogenous elicitor with respect to the endogenous elicitor in the plant-vitalizing agent is 0.1 to 5.

[17] The plant-vitalizing agent according to any one of [12] to [16], which comprises a xylooligosaccharide as the endogenous elicitor.

[18] The plant-vitalizing agent according to [17], which comprises both a cellooligosaccharide and a xylooligosaccharide as the endogenous elicitor.

[19] The plant-vitalizing agent according to [18], wherein the mass ratio of the cellooligosaccharide with respect to the xylooligosaccharide in the plant-vitalizing agent is 0.2 to 5.

[20] The plant-vitalizing agent according to any one of [12] to [19], which is applied to a plant at a concentration so that the total content of the exogenous elicitor and the endogenous elicitor is 0.1 to 500 ppm by mass.

[21] The plant-vitalizing agent according to any one of [12] to [20], which is applied to a plant by foliar application.

[22] The plant-vitalizing agent according to any one of [12] to [21], wherein the cotton is of the species hirsutum.

### Advantageous Effects of Invention

The method for cultivating cotton of the invention can increase harvest yields by applying a plant-vitalizing agent comprising an exogenous elicitor and an endogenous elicitor to cotton seedlings.

### DESCRIPTION OF EMBODIMENTS

Embodiments of the invention will now be explained. The following embodiments are merely examples of the invention and are not intended to be limitative in any way.

The method for cultivating cotton of this embodiment comprises applying a plant-vitalizing agent comprising an exogenous elicitor and an endogenous elicitor to a cotton seedling. The term “plant-vitalizing agent” includes not only substances that have effects of alleviating abiotic stresses such as temperature, light, water and salts that are involved in the growth of plants, but also effects of alleviating biological stresses such as pests.

The term “elicitor” generally refers to a substance that induces a biological defense reaction in a higher plant tissue or cultured cells, whereby it induces disease resistance by plant immunomechanisms. Plants are sensitive to elicitors by receptors present on leaf surfaces, initiating pathogen resistance reactions. This induces biological defense activity (immunity) in which various compounds are secreted against different pathogenic organisms. When an elicitor acts on a plant, it induces defense reactions such as synthesis and accumulation of phytoalexins and infection-specific proteins, production of active oxygen species, production of active nitrogen species, hypersensitive reactive cell death, and changes in gene expression, these reactions being thought to protect the plant from pathogenic organisms and increase disease resistance.

Phytoalexins are antimicrobial compounds synthesized and accumulated in the plant body due to action of elicitors, and the antimicrobial compounds produced differ depending on the plant variety. Typical phytoalexins include flavonoids, terpenoids and fatty acid derivatives. Active oxygen species kill pathogenic microorganisms, while active oxygen and active nitrogen species, either alone or in coordination, also function as signals to initiate various defense reactions. The disease resistance provided by such elicitor effects helps to augment resistance against a wide range of diseases, and it is therefore expected to be useful for agriculture.

### [Exogenous Elicitor]

As used herein, “exogenous elicitor” means an elicitor which is a substance derived from an organism other than the plant, such as a fungus, insect or crustacean, and while it is not particularly restricted other than having an elicitor effect, it will typically be chitin, chitosan or one of their oligosaccharides, or an insect-derived biomolecule.

The plant-vitalizing agent to be used in the method for cultivating cotton of the embodiment preferably includes a chitin oligosaccharide as an exogenous elicitor.

Chitin oligosaccharides contain partially deacetylated chitosan oligosaccharides, being oligosaccharides with several N-acetylglucosamines linked together which can generally be obtained by hydrolysis of crustacean-derived chitins, and they are also known as oligo-N-acetylglucosamines.

Specifically, chitin oligosaccharides are obtained by chemical or enzymatic partial hydrolysis of chitin prepared by a common method from shells of crustaceans such as crab or shrimp. A chitin oligosaccharide that is used is preferably one or a mixture of more than one selected from among N-acetylchitobiose, N-acetylchitotriose, N-acetylchitotetraose, N-acetylchitopentaose, N-acetylchitohexaose, N-acetylchitoheptaose and N-acetylchitooctaose. Among these, N-acetylchitopentaose, N-acetylchitohexaose and N-acetylchitoheptaose have particularly high elicitor effects.

Chitin oligosaccharides to be used for the embodiment are most preferably ones having the following chemical structure.

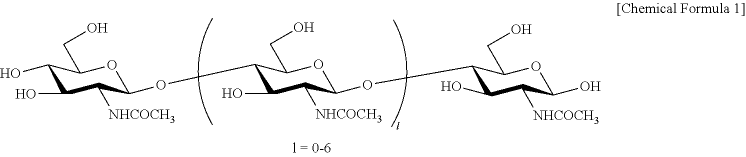

These include compounds wherein some of the acetyl groups (—COCH₃) in the formula are shed, converting —NHCOCH₃ to —NH₂ groups.

### [Endogenous Elicitor]

As used herein, “endogenous elicitor” means a plant-derived elicitor, with no particular restrictions other than having an elicitor effect, but typically it will be a cellulose or xylan produced from a plant, or an oligosaccharide of the same.

The plant-vitalizing agent to be used in the method for cultivating cotton of the embodiment preferably comprises at least one oligosaccharide selected from among cellooligosaccharides and xylooligosaccharides, as an endogenous elicitor.

Cellooligosaccharides are oligosaccharides polymerized by β-glycoside bonding of multiple glucose molecules, and in recent years they have been found to have functionality including moisture retention, stickiness inhibition, freshness functionality, starch aging reduction and protein denaturation inhibition, for which they are expected to have uses in the fields of medicine, cosmetics, foods and feed. In particular, cellooligosaccharides with a glucose polymerization degree of 3 or greater are even more promising in terms of increasing the functionality mentioned above and also providing new functionality. The cellooligosaccharides currently used in industry are produced by enzyme reaction, but their main components are glucose and dimeric cellobioses, whereas they contain almost no trimeric cellotriose or greater oligomers. In recent years, however, the present applicants have reported a method for producing cellooligosaccharides that comprise oligomers with a glucose polymerization degree of 3 to 6, in hydrolysis reaction of vegetable biomass using a carbon catalyst, by carrying out hydrothermal reaction while controlling the temperature-elevating rate, cooling rate, reaction temperature and reaction time (PTL 7).

Cellooligosaccharides to be used for the embodiment are most preferably ones having the following chemical structure.

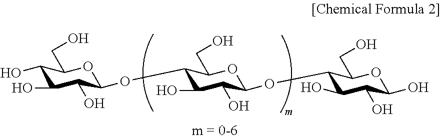

Xylooligosaccharides are oligosaccharides polymerized by β-glycoside bonding of multiple xylose molecules, and they are generally obtained by hydrolysis of xylan as the main component of hemicellulose, being marketed mainly for comestible purposes.

Xylooligosaccharides to be used for the embodiment are most preferably ones having the following chemical structure.

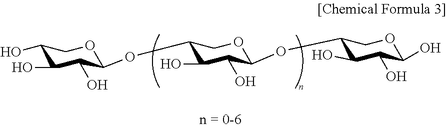

### [Plant-Vitalizing Agent]

The plant-vitalizing agent to be used in the method for cultivating cotton of the embodiment preferably includes at least the aforementioned exogenous elicitor and endogenous elicitor as active components. The mass ratio of the exogenous elicitor with respect to the endogenous elicitor in the plant-vitalizing agent (exogenous elicitor content/endogenous elicitor content) is preferably 0.1 to 5, more preferably 0.2 to 2 and even more preferably 0.3 to 0.6.

The plant-vitalizing agent more preferably comprises a xylooligosaccharide as the endogenous elicitor, and optimally it comprises both a cellooligosaccharide and a xylooligosaccharide. The mass ratio of the cellooligosaccharide with respect to the xylooligosaccharide in the plant-vitalizing agent (cellooligosaccharide content/xylooligosaccharide content) is preferably 0.2 to 5, more preferably 0.3 to 3 and even more preferably 0.4 to 1.2.

When the plant-vitalizing agent comprises a chitin oligosaccharide as the exogenous elicitor and both a cellooligosaccharide and a xylooligosaccharide as the endogenous elicitor, the percentage of each oligosaccharide with respect to the total content of the chitin oligosaccharide, cellooligosaccharide and xylooligosaccharide is preferably 10 to 50 mass % of the chitin oligosaccharide, 10 to 50 mass % of the cellooligosaccharide and 10 to 60 mass % of the xylooligosaccharide. The percentage of each oligosaccharide is more preferably 20 to 40 mass % of the chitin oligosaccharide, 20 to 40 mass % of the cellooligosaccharide and 20 to 55 mass % of the xylooligosaccharide.

The plant-vitalizing agent may also contain components other than the exogenous elicitor and endogenous elicitor as active components, such as antiseptic agents, spreading agents, anti-settling agents, thickeners, fillers and solvents. Antiseptic agents include potassium sorbate, paraoxybenzoic acid esters, benzoin, sodium dehydroacetate, hinokitiol, phenoxyethanol, polyaminopropyl biguanide and polylysine. Spreading agents are viscous liquids composed mainly of surfactants, and they are not particularly restricted so long as they can be used as spreading agents for plant-vitalizing agents, examples including polyoxyethylene nonylphenyl ethers, sorbitan fatty acid esters and polyoxyethylene hexitan fatty acid esters. Anti-settling agents include polyphosphoric acid and polyphosphoric acid salts, or polycarboxylic acid-type polymer surfactants. Thickeners include carboxymethyl cellulose (CMC), polyacrylamide, water-soluble polymers such as starch, or molasses, alcohol fermentation concentrate waste liquids and amino acid fermentation concentrate waste liquids. Fillers include lactose and starch. A solvent is used for the purpose of diluting the active component to a suitable liquid concentration, or to facilitate dispersion onto plants. Water is preferred as the solvent.

The plant-vitalizing agent to be used in the method for cultivating cotton of the embodiment may be prepared as a product in any form such as powder, granules or liquid, but it is generally preferred to be in easily dispersible liquid form. When a liquid plant-vitalizing agent is to be used, the active component concentration in the plant-vitalizing agent during dispersion onto a plant is preferably 0.1 to 500 ppm by mass, more preferably 0.5 to 200 ppm by mass and even more preferably 1 to 100 ppm by mass. The active component concentration in the plant-vitalizing agent is the total content of the exogenous elicitor and endogenous elicitor in the plant-vitalizing agent. If the dispersion concentration is 0.1 ppm by mass or greater the effect as a plant-vitalizing agent will be exhibited more effectively. If the dispersion concentration is 500 ppm by mass or lower it will be possible for disease resistance to be exhibited without inhibiting growth of the plant.

The plant-vitalizing agent used may be a commercially available product with the active component concentration already prepared to the specified concentration, but in most cases a stock solution of the plant-vitalizing agent comprising the exogenous elicitor and endogenous elicitor at high concentration will be used by dilution with water. When the plant-vitalizing agent stock solution is used as a dilution (such as a 1000× dilution), the total content of the exogenous elicitor and endogenous elicitor in the plant-vitalizing agent stock solution is preferably 0.05 to 10 mass %, more preferably 0.1 to 8 mass % and even more preferably 0.5 to 6 mass %.

### [Cotton]

The type of cotton to be cultivated by the cultivation method of the embodiment is not particularly restricted, and species such as hirsutum, barbadense, arboreum and herbaceum may be mentioned. Preferred are the species hirsutum and barbadense, with the species hirsutum being more preferred.

### [Cultivation Method]

The cultivation form for cotton is not particularly restricted, and it may be outdoor cultivated, greenhouse cultivated or hydroponically cultivated. For cultivation of cotton, the seeds may be directly sowed in the field, or seeding and raising of seedlings may be divided, with field planting of the seedlings. Since planting after development of 4 to 5 or more true leaves is disadvantageous for growth, they are preferably directly sowed or planted at a stage up to development of 2 to 3 true leaves.

For cultivation by direct seeding as an example, the following method may be used.

The cultivation environment is preferably a field with weakly alkaline soil, adequate drainage, satisfactory ventilation and sufficient sun exposure. During the period when the optimal temperature for germination is 20 to 25° C., ridges about 70 to 90 cm in width are formed in the field that has been mixed with organic fertilizer and slow-release chemical fertilizer, and 2 to 3 grains each are seeded at 50 to 60 cm spacings, covered with soil, compacted, and thoroughly watered. After germination, the plants are thinned leaving those with most satisfactory growth. Water is applied only onto dry soil surface, avoiding excessive humidity. For ground planting it is preferred to avoid excessive top dressing in order to improve flowering.

Development of 4 to 5 true leaves is seen at about 2 to 3 weeks after germination, and during the period of about 1 to 1.5 months thereafter, roots begin to grow while the height above ground remains at about 10 cm. For about 1 to 2 months during the subsequent period when the atmospheric temperature rises, the ground top portion undergoes rapid growth and flowering begins. During the 40 to 50 days after flowering, cotton balls appear and may be harvested.

The method for cultivating cotton of this embodiment includes applying the plant-vitalizing agent to seedlings. As used herein, “seedling” means seedlings from germination to planting when seeding and raising of seedlings are carried out separately, or when seeds are directly sowed in the field, it means seedlings from germination until the 3rd week.

According to one aspect, in order to obtain full seedlings, preferably the plant-vitalizing agent is used at least once for seedlings 2 to 15 days after germination, more preferably it is used at least once for seedlings at 2 to 10 days, and even more preferably it is used at least once for seedlings at 3 to 7 days. The number of times that the plant-vitalizing agent is used during the period of 2 to 15 days after germination is preferably 1 to 2 times and more preferably once.

According to another aspect, when seeding and raising of seedlings are carried out separately, the agent is preferably used at least once for seedlings from 16 days after germination until planting. The number of times the plant-vitalizing agent is used during the period from 16 days after germination until planting will differ depending on the raising period, but it is preferably once during 5 days to 30 days, and more preferably once during 10 days to 20 days.

According to yet another aspect, when seeds are directly sowed in the field, the agent is preferably again used at least once for seedlings from 16 days until 3 weeks after germination.

In order to obtain fuller seedlings, most preferably the plant-vitalizing agent is used at least once for seedlings 2 to 15 days after germination, and at least once for the seedlings thereafter, at a frequency of once during 5 days to 10 days.

According to another aspect of the method for cultivating cotton of this embodiment, the plant-vitalizing agent is preferably also applied to plant bodies after the seedling stage. As used herein, “plant body after the seedling stage” refers to a plant body that has passed the aforementioned “seedling” stage. Specifically, it refers to the plant body after planting when seeding and raising of seedlings are carried out separately, or when seeds are directly sowed in the field, it refers to the plant body after the period from germination until the 3rd week has elapsed.

According to one aspect, when seeding and raising of seedlings are carried out separately, planting is preferably carried out with seedlings having development of 1 or 2 true leaves at about 10 days after seeding. Planting is preferably in an environment selected for adequate sunshine and ventilation, while avoiding dense planting. The method of applying the plant-vitalizing agent is preferably usage at least once to the plant bodies during 1 and 2 weeks after planting. Afterwards it is preferably used 2 to 10 times, once every one to two weeks.

According to yet another aspect, when seeds are directly sowed in the field, the plant-vitalizing agent is preferably used at least once for the plant bodies after 3 weeks have elapsed after germination. The frequency of use is preferably 2 to 10 times, once every one to two weeks.

Application of the plant-vitalizing agent to cotton may be by any method commonly used by those skilled in the art without any particular restriction on the dispersion method, examples including a method of direct dispersion onto the leaves or stems of the plant, a method of dispersion into culture medium or soil in which the plant is to be cultivated, or a method of mixing into fertilizer and then dispersion into culture medium or soil. For mixing into fertilizer, the type of fertilizer is not restricted and may be chemical fertilizer comprising nitrogen, phosphoric acid and potassium, or organic fertilizer containing oil residue, fish residue, bone powder, sea weed powder, amino acids, saccharides or vitamins. The dispersion method is preferably carried out by foliar application, as this will allow the elicitor activity to be effectively exhibited. Foliar application may be carried out by a method commonly known to those skilled in the art, using a mechanical power atomizer, shoulder atomizer, broadcaster, sprayer, manned or unmanned helicopter, duster or hand sprayer.

The amount of dispersion of the plant-vitalizing agent is preferably a dispersion amount for 0.1 ng to 100 ng of active component per 1 cm² leaf surface, and more preferably a dispersion amount for 1 ng to 20 ng of active component per 1 cm² of leaf surface. Since it is difficult in practice to achieve selective dispersion on the leaf surfaces alone or adhesion of all of the dispersed solution onto the leaf surfaces on the field, the active component to be used at 0.01 g to 20 g per 100 m² of cultivated area is preferably diluted to a concentration of 1 ppm by mass to 100 ppm by mass in the plant-vitalizing agent, and dispersed evenly onto the plant bodies. More preferably, the active component to be used at 0.1 g to 10 g per 100 m² of cultivated area is diluted to a concentration of 10 ppm by mass to 500 ppm by mass in the plant-vitalizing agent.

Soil management for the method for cultivating cotton of this embodiment is preferably carried out by a common agricultural method.

### (Effect of Plant-Vitalizing Agent)

A method for cultivating cotton of this embodiment comprises applying a plant-vitalizing agent comprising an exogenous elicitor and an endogenous elicitor to a cotton seedling. The plant-vitalizing agent comprising an exogenous elicitor and an endogenous elicitor is also preferably applied to the post-seedling stage plant body of cotton. The reason why an effect is exhibited by applying the aforementioned plant-vitalizing agent during this period is not fully understood. It is possible that with application of an exogenous elicitor (such as one derived from a chitin oligosaccharide), disease resistance from herbivores is imparted to the plant body, but that this results in growth inhibition when in excess. When an endogenous elicitor (such as one derived from a cellooligosaccharide or xylooligosaccharide) is applied, on the other hand, this causes the plant body to recognize its own cellular damage or disrupting components (DAMPs: Damage-Associated Molecular Patterns), thereby promoting its own growth via acquired immunity and cellular repair. In the method for cultivating cotton according to the embodiment, applying the plant-vitalizing agent comprising the exogenous elicitor and endogenous elicitor to the early-stage seedling is thought to allow growth of a tough seedling with disease resistance while reducing growth inhibition. Consecutive use of a plant-vitalizing agent on a tough raised plant body can take advantage of the growth-promoting effect of the endogenous elicitor without being significantly affected by growth inhibition by the exogenous elicitor, so that the complementary action of both agents allows a high growth-developing effect to be exhibited. It is therefore estimated that application of the plant-vitalizing agent at least once to seedlings and at least once to plant bodies after the seedling stage during cultivation of cotton, makes it possible to achieve robust growth of the plant bodies and increased harvest yield.

The following Examples serve merely for concrete illustration of the invention and are not intended to be limitative on the invention.

### Examples

### [1. Preparation of Oligosaccharides]

### (1) Chitin Oligosaccharide

A 10 g portion of chitin powder (purified chitin by Wako Pure Chemical Industries, Ltd.) was dispersed in 30 mL of water containing 1.2 g of 85% phosphoric acid (special grade reagent by Wako Pure Chemical Industries, Ltd.), the powder that had been dried under reduced pressure was placed in a 250 mL-volume alumina pot together with 100 g of alumina balls with diameters of 5 mm, and this was then set in a planetary ball mill (PULVERISETTE6 by Fritsch Co.) and treatment was carried out continuously for 6 hours at 500 rpm to obtain a reaction product. The temperature was initially room temperature, and temperature increase was allowed to proceed by shear heat release.

The reaction product was then suspended in water, and after neutralizing with calcium hydroxide, the resulting slurry solution was filtered with a Nutsche filter using 5B filter paper, and the recovered filtrate was freeze-dried to obtain the chitin oligosaccharide powder.

### (2) Cellooligosaccharide

A 271 g portion (1.8% water content, 266 g dry mass) of cotton linter pulp (cellulose content: 97%, Tokokosen Corp.) was mixed with 38 g of 85 mass % phosphoric acid (special grade reagent, product of FujiFilm-Wako Pure Chemical Industries) using a food blender (Model: HBF500S by Hamilton Beach Co.), to obtain 309 g of a reaction starting material (3.4% water content, phosphoric acid content: 10.4%).

Next, the 309 g of reaction starting material was loaded into a vibrating mill (device name: MB-1, product of Chuo Kakohki Co., Ltd., 5 L pot size), together with 13 kg of φ¾-inch carbon steel balls, and subjected to hydrolysis by dry grinding for 24 hours under conditions with a total amplitude of 8 mm, a vibrational frequency of 16.2 Hz and a jacket circulation water temperature of 75° C., after which the reaction powder was recovered.

After then placing 10 g of the reaction powder and 90 g of ion-exchanged water in a 200 L beaker, a magnetic stirrer was used for 1 hour of stirring at 25° C. to obtain a cellulose hydrolysate extract.

Next, 1.3 g of a 40 mass % aqueous calcium hydroxide solution was added to the extract, and a magnetic stirrer was used for 1 hour of stirring at 25° C. to prepare a neutral solution, collecting the supernatant using a centrifuge apparatus and freeze-drying it to obtain cellooligosaccharide powder.

### (3) Xylooligosaccharide

Acremonium cellulolyticus TN (FERM P-18508) was shake cultured for 6 days at 30° C. in a 500 mL flask containing 100 mL of liquid medium (50 g/L AVICEL, 24 g/L KH₂O₄, 5 g/L ammonium sulfate, 4.7 g/L potassium tartrate·½H₂O, 4 g/L urea, 1 g/L Tween80, 1.2 g/L MgSO₄·7H₂O, 10 mg/L ZnSO₄·7H₂O, 10 mg/L MnSO₄·5H₂O, 10 mg/L CuSO₄·5H₂O). A 5 g portion of corn cob powder was suspended in 50 mL of centrifuged supernatant of the obtained culture solution, and reacted with stirring at 50° C. for 72 hours. Centrifuged supernatant from the reaction mixture was freeze-dried to obtain xylooligosaccharide powder.

### [2. Cultivation of Cotton]

### (1) Preparation of Plant-Vitalizing Agent

Each oligosaccharide prepared in [1. Preparation of oligosaccharides] was dissolved in water while stirring with a stirrer in a compositional ratio for 1000 times the active component concentration (ppm by mass) in the plant-vitalizing agents of Examples 1 to 11 and Comparative Examples 1 to 5 listed in Table 1, after which the bacteria were removed with a 0.45 μm filter, to obtain plant-vitalizing agent stock solutions. Each stock solution was diluted 1000-fold with water and used for the following cultivation test. The plant-vitalizing agent obtained by 1000-fold dilution of the stock solution may also be referred to hereunder as “plant-vitalizing agent dilution”. The compositional ratios of the oligosaccharides in the tables are represented as mass %.

### (2) Cultivation Test 1 (Examples 1 to 11 and Comparative Examples 1 to 5)

Field cultivation of cotton was carried out in a vinyl greenhouse using a field with a total area of 100 m². Two weeks prior to the expected seeding period, the field was plowed and mixed with magnesium lime and mulch. Ridges with widths of 80 cm were formed in the field that had been prepared in early May, and the cotton (hirsutum) seeds were sowed at 3 grains each with 60 cm spacings. The covered soil was lightly compacted and thoroughly watered, and germination occurred after 10 days. Upon complete development of the cotyledons, the plants were thinned leaving only those with satisfactory growth. These were divided into 20 sections with 10 plants/section, and chemical fertilizer was used according to a common agricultural method.

The plant-vitalizing agent dilution was dispersed onto the germinated cotton seedlings and the plant bodies after the seedling stage, to wetting of the leaf surfaces and soil, under the conditions shown in Table 1.

Aqueous solutions (plant-vitalizing agent dilutions) were prepared to the active component concentrations of plant-vitalizing agent for each condition with 2 kg/section each time, and a procedure of foliar application and watering of the soil near the roots using a watering can was carried out under the conditions listed in Table 1, after which the average harvest yields for each section (10 plants) were measured and compared between the different conditions.

The harvest yields were measured by picking cotton balls and measuring the mean weight per plant. The test results are shown in Table 1.

TABLE 1

| | | | | Example 1 | Example 2 | Example 3 | Example 4 |
|---|---|---|---|---|---|---|---|
| Plant species | | | | Cotton | Cotton | Cotton | Cotton |
| Conditions | Active component concentration in plant-vitalizing agent (ppm by mass) | | | 20 | 20 | 20 | 20 |
| | Seedling stage | Exogenous elicitor | Chitin oligosaccharide | — | 34% | 34% | 34% |
| | (4 days after | Endogenous elicitor | Cellooligosaccharide | — | 33% | 33% | 33% |
| | germination) | | Xylooligosaccharide | — | 33% | 33% | 33% |
| | Seedling stage | Exogenous elicitor | Chitin oligosaccharide | 34% | — | — | 34% |
| | (14 days after | Endogenous elicitor | Cellooligosaccharide | 33% | — | — | 33% |
| | germination) | | Xylooligosaccharide | 33% | — | — | 33% |
| | 3 weeks to 2 | Exogenous elicitor | Chitin oligosaccharide | 34% | 34% | — | 34% |
| | months after | Endogenous elicitor | Cellooligosaccharide | 33% | 33% | — | 33% |
| | germination | | Xylooligosaccharide | 33% | 33% | | 33% |
| | (once/2 weeks) | | | | | | |
| Results | Average harvest yield (g/stock) | | | 18.9 | 20.6 | 20.2 | 21.4 |
| | | | | Example 5 | Example 6 | Example 7 | Example 8 |
| Plant species | | | | Cotton | Cotton | Cotton | Cotton |
| Conditions | Active component concentration in plant-vitalizing agent (ppm by mass) | | | 20 | 20 | 20 | 100 |
| | Seedling stage | Exogenous elicitor | Chitin oligosaccharide | — | 25% | 25% | — |
| | (4 days after | Endogenous elicitor | Cellooligosaccharide | — | 25% | 25% | — |
| | germination) | | Xylooligosaccharide | — | 50% | 50% | — |
| | Seedling stage | Exogenous elicitor | Chitin oligosaccharide | 25% | — | 25% | 34% |
| | (14 days after | Endogenous elicitor | Cellooligosaccharide | 25% | — | 25% | 33% |
| | germination) | | Xylooligosaccharide | 50% | — | 50% | 33% |
| | 3 weeks to 2 | Exogenous elicitor | Chitin oligosaccharide | 25% | 25% | 25% | 34% |
| | months after | Endogenous elicitor | Cellooligosaccharide | 25% | 25% | 25% | 33% |
| | germination | | Xylooligosaccharide | 50% | 50% | 50% | 33% |
| | (once/2 weeks) | | | | | | |

| | | | | | |
|---|---|---|---|---|---|
| Results | Average harvest yield (g/stock) | 19.1 | 20.9 | 21.8 | 20.9 |

| | | | | | | | Comp. |
|---|---|---|---|---|---|---|---|
| | | | | Example 9 | Example 10 | Example 11 | Example 1 |
| Plant species | | | | Cotton | Cotton | Cotton | Cotton |
| Conditions | Active component concentration in plant-vitalizing agent (ppm by mass) | | | 100 | 100 | 100 | 0 |
| | Seedling stage | Exogenous elicitor | Chitin oligosaccharide | 34% | — | 25% | — |
| | (4 days after | Endogenous elicitor | Cellooligosaccharide | 33% | — | 25% | — |
| | germination) | | Xylooligosaccharide | 33% | — | 50% | — |
| | Seedling stage | Exogenous elicitor | Chitin oligosaccharide | 34% | 25% | 25% | — |
| | (14 days after | Endogenous elicitor | Cellooligosaccharide | 33% | 25% | 25% | — |
| | germination) | | Xylooligosaccharide | 33% | 50% | 50% | — |
| | 3 weeks to 2 | Exogenous elicitor | Chitin oligosaccharide | 34% | 25% | 25% | — |
| | months after | Endogenous elicitor | Cellooligosaccharide | 33% | 25% | 25% | — |
| | germination | | Xylooligosaccharide | 33% | 50% | 50% | |
| | (once/2 weeks) | | | | | | |

| | | | | | |
|---|---|---|---|---|---|
| Results | Average harvest yield (g/stock) | 22.6 | 21.1 | 23.6 | 16.2 |

| | | Comp. | Comp. | Comp. | Comp. |
|---|---|---|---|---|---|
| | | Example 2 | Example 3 | Example 4 | Example 5 |
| Plant species | | Cotton | Cotton | Cotton | Cotton |
| Conditions | Active component concentration in plant-vitalizing agent (ppm by mass) | 20 | 20 | 20 | 20 |

| | | | | | | |
|---|---|---|---|---|---|---|
| Seedling stage | Exogenous elicitor | Chitin oligosaccharide | — | — | 100% | — |
| (4 days after | Endogenous elicitor | Cellooligosaccharide | — | — | — | 34% |
| germination) | | Xylooligosaccharide | — | — | — | 66% |
| Seedling stage | Exogenous elicitor | Chitin oligosaccharide | — | 100% | 100% | — |
| (14 days after | Endogenous elicitor | Cellooligosaccharide | — | — | — | 34% |
| germination) | | Xylooligosaccharide | — | — | — | 66% |
| 3 weeks to 2 | Exogenous elicitor | Chitin oligosaccharide | 34% | 100% | 100% | — |
| months after | Endogenous elicitor | Cellooligosaccharide | 33% | — | — | 34% |
| germination | | Xylooligosaccharide | 33% | | | 66% |
| (once/2 weeks) | | | | | | |

| | | | | | |
|---|---|---|---|---|---|
| Results | Average harvest yield (g/stock) | 17.0 | 17.1 | 17.4 | 17.6 |

### [3. Cultivation of Brassicaceae Plants (Reference Examples 1 to 3)]

A test was also conducted using komatsuna as a Brassicaceae plant.

Ridges were formed in the composted and plowed field while ensuring ridge spacings of about 15 to 20 cm and the komatsuna (Inamura) seeds were sowed at spacings of 1 to 1.5 cm, and after light soil covering and compaction, they were thoroughly irrigated. The plant-vitalizing agent dilution was dispersed onto the germinated komatsuna seedlings with appropriate thinning to wetting of the leaf surfaces and soil, under the conditions shown in Table 2. Harvesting was carried out when the plant heights reached 20 to 25 cm, and the harvest weights per stock were compared for 20 seedlings. The test results are shown in Table 2.

TABLE 2

| | | | | | | Ref. |
|---|---|---|---|---|---|---|
| | | | | Ref. | Ref. | Example |
| | | | | Example 1 | Example 2 | 3 |
| Plant species | | | | Komatsuna | Komatsuna | Komatsuna |
| Conditions | Active component concentration in plant-vitalizing agent (ppm by mass) | | | 0 | 20 | 20 |
| | Seedling stage | Exogenous elicitor | Chitin oligosaccharide | — | — | 34% |
| | (4 days after | Endogenous elicitor | Cellooligosaccharide | — | — | 33% |
| | germination) | | Xylooligosaccharide | — | — | 33% |
| | Seedling stage | Exogenous elicitor | Chitin oligosaccharide | — | — | 34% |
| | (4 weeks after | Endogenous elicitor | Cellooligosaccharide | — | — | 33% |
| | germination) | | Xylooligosaccharide | — | — | 33% |
| | 4 weeks to harvest | Exogenous elicitor | Chitin oligosaccharide | — | 34% | 34% |
| | (once/2 weeks) | Endogenous elicitor | Cellooligosaccharide | — | 33% | 33% |
| | | | Xylooligosaccharide | — | 33% | 33% |

| | | | | |
|---|---|---|---|---|
| Results | Harvest yield per stock (g/stock) | 34 | 45 | 46 |

The results in Table 1 confirmed that harvest yield can be markedly increased during cultivation of cotton, if a plant-vitalizing agent including both an exogenous elicitor and an endogenous elicitor is used for seedlings. Based on the results in Table 2, no significant increase in weight per stock could be obtained during cultivation of komatsuna as a Brassicaceae plant, even when a plant-vitalizing agent including both an exogenous elicitor and an endogenous elicitor were used for seedlings in addition to the growth phase before harvesting.

1. A method for cultivating cotton, wherein the method comprises applying a plant-vitalizing agent comprising an exogenous elicitor and an endogenous elicitor at least once to a seedling of the plant.

2. The method for cultivating cotton according to claim 1, wherein the method comprises applying a plant-vitalizing agent to a seedling of the plant at least once at 2 to days after germination.

3. The method for cultivating cotton according to claim 1, wherein the method comprises applying a plant-vitalizing agent to a plant body at least once after the seedling stage.

4. The method for cultivating cotton according to claim 1, wherein the exogenous elicitor is a chitin oligosaccharide, and the endogenous elicitor is at least one type of oligosaccharide selected from among cellooligosaccharides and xylooligosaccharides.

5. The method for cultivating cotton according to claim 1, wherein the mass ratio of the exogenous elicitor with respect to the endogenous elicitor in the plant-vitalizing agent is 0.1 to 5.

6. The method for cultivating cotton according to claim 1, which comprises a xylooligosaccharide as the endogenous elicitor.

7. The method for cultivating cotton according to claim 6, which comprises both a cellooligosaccharide and a xylooligosaccharide as the endogenous elicitor.

8. The method for cultivating cotton according to claim 7, wherein the mass ratio of the cellooligosaccharide with respect to the xylooligosaccharide in the plant-vitalizing agent is 0.2 to 5.

9. The method for cultivating cotton according to claim 1, which comprises applying the plant-vitalizing agent to a plant at a concentration so that the total content of the exogenous elicitor and the endogenous elicitor is 0.1 to 500 ppm by mass.

10. The method for cultivating cotton according to claim 1, which comprises applying the plant-vitalizing agent to a plant by foliar application.

11. The method for cultivating cotton according to claim 1, wherein the cotton is of the species hirsutum.

12. A plant-vitalizing agent comprising an exogenous elicitor and an endogenous elicitor, to be used for cultivation of cotton, which is applied at least one time to a seedling of the plant.

13. The plant-vitalizing agent according to claim 12, which is applied at least once to the seedling 2 to 15 days after germination.

14. The plant-vitalizing agent according to claim 12, which is applied at least once to the plant body after the seedling stage.

15. The plant-vitalizing agent according to claim 12, wherein the exogenous elicitor is a chitin oligosaccharide, and the endogenous elicitor is at least one type of oligosaccharide selected from among cellooligosaccharides and xylooligosaccharides.

16. The plant-vitalizing agent according to claim 12, wherein the mass ratio of the exogenous elicitor with respect to the endogenous elicitor in the plant-vitalizing agent is 0.1 to 5.

17. The plant-vitalizing agent according to claim 12, which comprises a xylooligosaccharide as the endogenous elicitor.

18. The plant-vitalizing agent according to claim 17, which comprises both a cellooligosaccharide and a xylooligosaccharide as the endogenous elicitor.

19. The plant-vitalizing agent according to claim 18, wherein the mass ratio of the cellooligosaccharide with respect to the xylooligosaccharide in the plant-vitalizing agent is 0.2 to 5.

20. The plant-vitalizing agent according to claim 12, which is applied to a plant at a concentration so that the total content of the exogenous elicitor and the endogenous elicitor is 0.1 to 500 ppm by mass.

21. The plant-vitalizing agent according to claim 12, which is applied to a plant by foliar application.

22. The plant-vitalizing agent according to claim 12, wherein the cotton is of the species hirsutum.
